(19) United States
(12) Patent Application Publication
(10) Pub. No.: US 2016/0250005 A1
(43) Pub. Date: Sep. 1, 2016

(54) DENTAL ARTICULATORS

(71) Applicants: Pallavi MEHTA, Cerritos, CA (US); Ashwin MEHTA, Cerritos, CA (US)

(72) Inventors: Ashwin MEHTA, Cerritos, CA (US); Pallavi MEHTA, Cerritos, CA (US)

(21) Appl. No.: 14/633,107

(22) Filed: Feb. 26, 2015

(51) Int. Cl. A61C 11/08

(52) U.S. Cl. CPC A61C 11/084

(57) ABSTRACT

Dental articulators for use with dental models are described. In one embodiment, a dental articulator may include a fixed portion configured to be fixedly coupled to a dental model. The fixed portion may have a first coupling. The dental articulator may also include a removable portion configured to be coupled to a hinge. The removable portion may have a second coupling configured to be removably coupled to the first coupling.

### BACKGROUND

Dental articulators are used with dental models to reproduce jaw movements. Dental articulators may allow the upper model and lower model of a dental model to be positioned and adjusted to reproduce a particular bite. Once the bite adjustments are made, the bite may be fixed. After the bite is fixed, dental articulators may continue to allow the upper model and lower model of the dental model to be opened and closed.

For subsequent bite adjustments, a dental articulator may need to be removed from the dental model. Because dental articulators may be glued or otherwise fixedly coupled to dental models, removing the dental articulator may risk causing damage to the dental model, especially if bite adjustments are made repeatedly over time.

Some dental articulators may be configured to be removable in order to facilitate subsequent bite adjustments. However, the removability features of such dental articulators also increases the likelihood that the dental articulator will become inadvertently detached from the dental model when the dental model is opened and closed, especially if opened and closed repeatedly.

What is needed is a dental articulator which allows subsequent bite adjustments of a dental model. What is also needed is a dental articulator which reduces the likelihood of becoming inadvertently detached from a dental model when the dental model is opened and closed.

### SUMMARY

Dental articulators for use with a dental model are described. In one embodiment, a dental articulator may include a fixed portion configured to be fixedly coupled to a dental model. The fixed portion may have a first coupling. The dental articulator may also include a removable portion configured to be coupled to a hinge. The removable portion may have a second coupling configured to be removably coupled to the first coupling.

Methods for using a dental articulator with a dental model are described. In one embodiment, the method may include fixedly coupling a fixed portion to a dental model. The fixed portion may have a first coupling. The method may also include removably coupling a removable portion to the fixed portion. The removable portion may have a second coupling configured to be removably coupled to the fixed portion. The method may also include coupling a hinge to the removable portion.

### BRIEF DESCRIPTION OF THE DRAWINGS

FIGS. 1A-1E show one embodiment of a dental articulator 1000.

FIGS. 2A-2F show one embodiment of a method of using dental articulator 1000.

FIGS. 3A-3D show various embodiments of track 1121 and mating rail 1221.

FIG. 3E shows another embodiment of first coupling 1120 and second coupling 1220.

FIGS. 4A and 4C show one embodiment of a dental articulator 1000, including a track 1121 and a mating rail 1221, coupled to a dental model 100.

FIGS. 4B and 4D show another embodiment of a dental articulator 1000, including a twist connector 1127 and a mating connector 1227, coupled to a dental model 100.

FIG. 4E shows yet another embodiment of a dental articulator 1000, including a twist connector 1127 and a mating connector 1227, coupled to a dental model 100.

### DETAILED DESCRIPTION

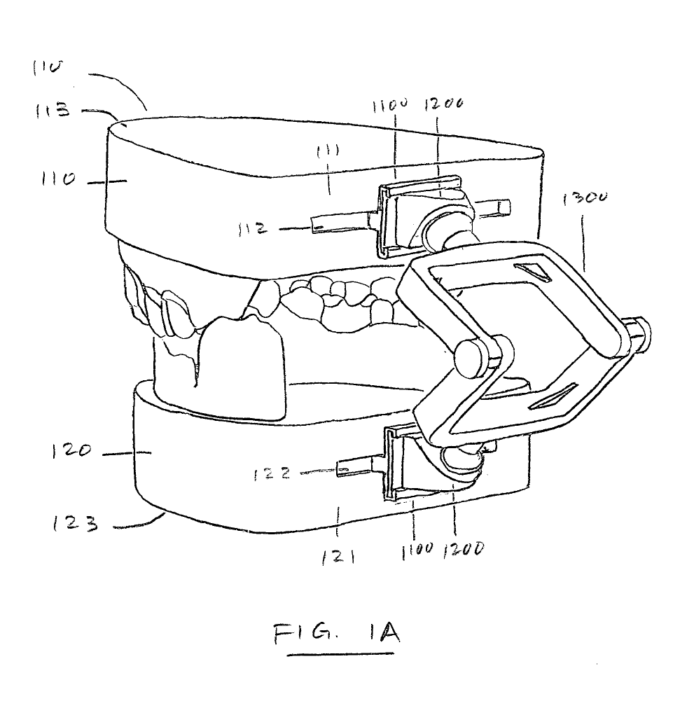

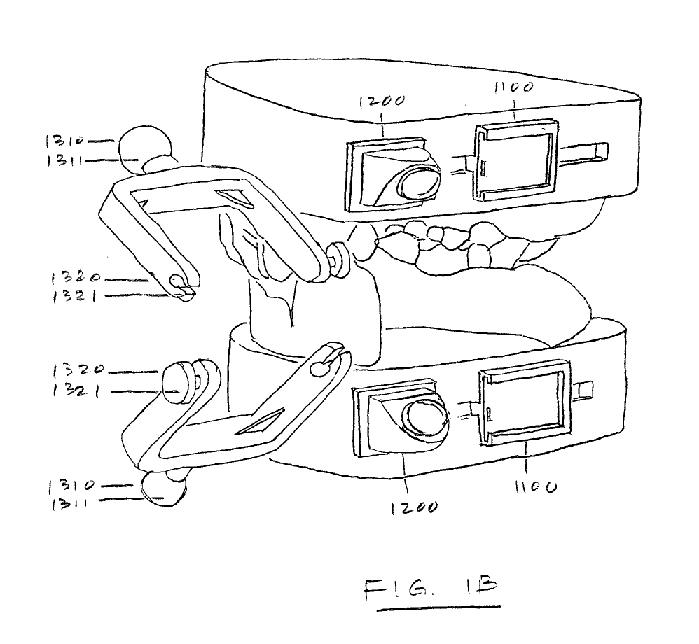

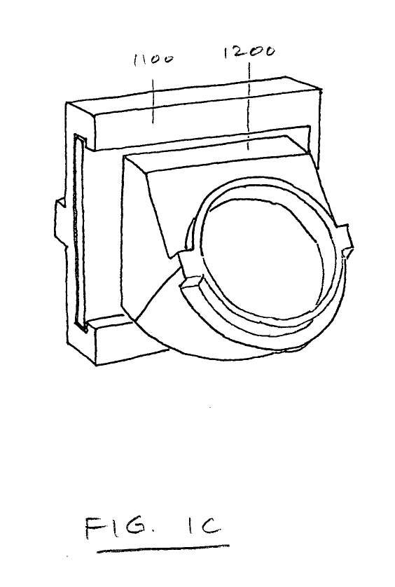

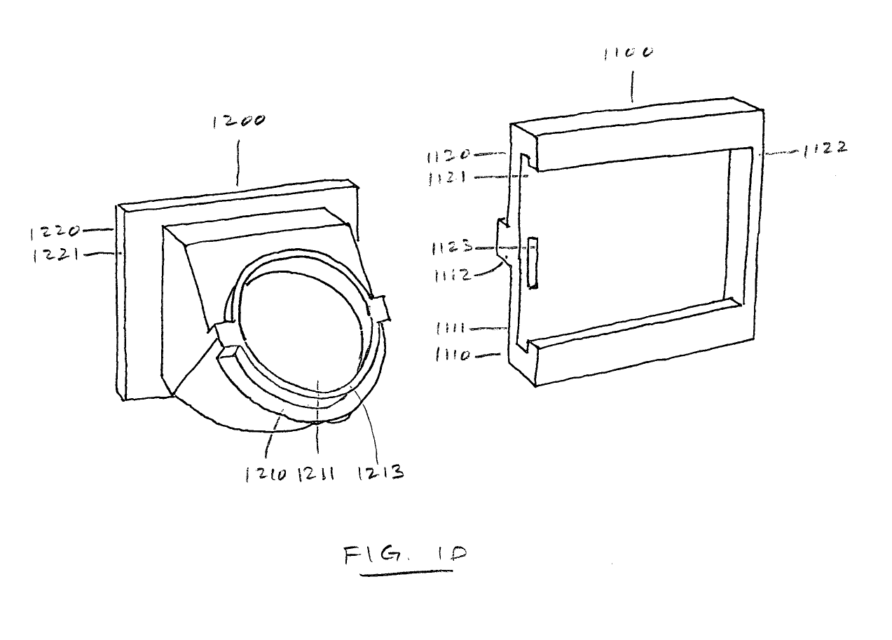

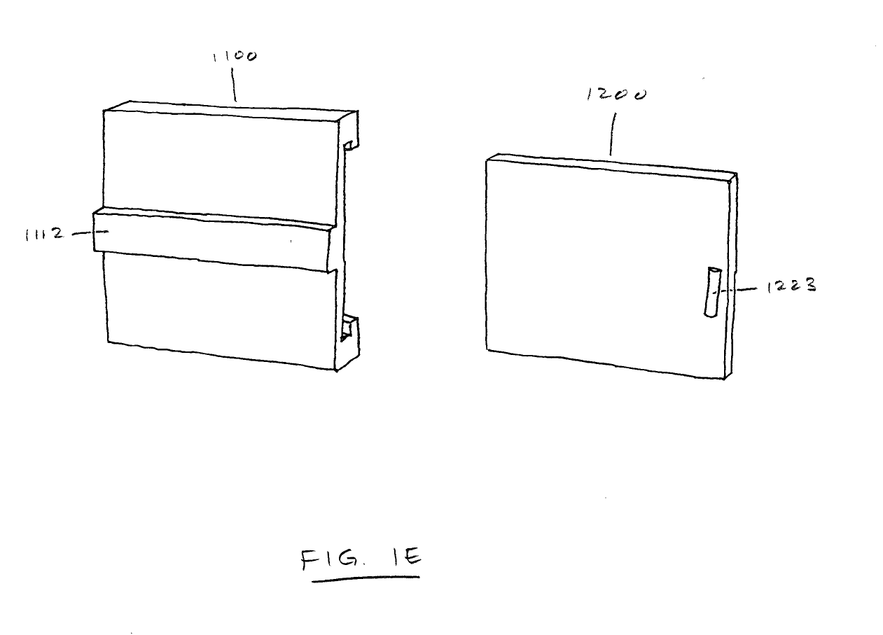

FIGS. 1A-1E show one embodiment of a dental articulator 1000. FIGS. 1A-1B show assembled and disassembled views, respectively, of dental articulator 1000 and a dental model 100. FIG. 1C shows an assembled view of fixed portion 1100 and removable portion 1200. FIG. 1D shows a disassembled view of fixed portion 1100 and removable portion 1200. FIG. 1E shows another disassembled view of fixed portion 1100 and removable portion 1200.

Dental articulator 1000 is configured to be coupled to a dental model 100. Dental model 100 may include an upper model 110 and a lower model 120. Upper model 110 may include a back surface 111 and a top surface 113. Upper model 110 may include a recess 112. Recess 112 may include a groove, channel, cutaway portion, or other feature to facilitate coupling to dental articulator 1000. Recess 112 may be formed in back surface 111. Alternatively, recess 112 may be formed in top surface 113 and/or one or more portions of dental model 100. Lower model 120 may include a back surface 121 and a bottom surface 123. Lower model 120 may include a recess 122. Recess 122 may include a groove, channel, cutaway portion, or other feature to facilitate coupling to dental articulator 1000. Recess 122 may be formed in back surface 121. Alternatively, recess 122 may be formed in bottom surface 123 and/or one or more other portions of dental model 100. Dental model 100 may also include a tray, base former, or other components.

Dental articulator 1000 includes a fixed portion 1100 and a removable portion 1200. Fixed portion 1100 is configured to be fixedly coupled to dental model 100. Removable portion 1200 is configured to be removably coupled to fixed portion 1100. Dental articulator 1000 may also include a hinged portion 1300. Hinged portion 1300 may be configured to be coupled to removable portion 1200.

One fixed portion 1100 may be used for upper model 110, and another fixed portion 1100 may be used for lower model 120. A removable portion 1200 may be used for each fixed portion 1100. A hinged portion 1300 may be used with both removable portions 1200. Alternatively, a fixed portion 1100 and a removable portion 1200 may be used for just one of either upper model 110 or lower model 120, and a different component or device, such as a non-removable component, may be used for the remaining model.

Fixed portion 1100 may include a model interface 1110 and a first coupling 1120. Model interface 1110 may be configured to be coupled to dental model 100. Model interface 1110 may be configured to be coupled to back surface 111 or back surface 121. Alternatively, model interface 1110 may be configured to be coupled to top surface 113, bottom surface 123, or one or more other portions of dental model 100. Model interface 1110 may be configured to be at least partially inserted into recess 112 and recess 122. Model interface 1110 may be fixedly coupled to dental model 100 using an adhesive, double-sided tape, or other suitable method. Model interface 1110 may include a plate 1111 configured to conform to back surface 111 or back surface 121, or one or more other portions of dental model 100. Plate 1111 may be planar. Alternatively, plate 1111 may be L-shaped or other suitable shape. Plate 1111 may include a tab 1112 configured to be at least partially inserted into recess 112 or recess 122. Alternatively, plate 1111 may be flat, without any protruding elements. Plate 1111 may include a lip 1113 configured to prevent an adhesive from entering first coupling 1120.

Removable portion 1200 may include a bite adjuster 1210 and a second coupling 1220. Bite adjuster 1210 may be configured to be coupled to hinged portion 1300. Bite adjuster 1210 may include a socket 1211. Socket 1211 may include a lip 1213 configured to prevent an adhesive from entering socket 1211. Lip 1213 may extend completely or partially around socket 1211. Alternatively, bite adjuster 1210 may include a ball, a universal joint, or other suitable rigid or flexible coupling. Still alternatively, bite adjuster 1210 may include a rigid coupling. Second coupling 1220 may be configured to be removably coupled to first coupling 1120.

Hinged portion 1300 may include a bite adjuster 1310 and an upper-lower joint 1320. Bite adjuster 1310 may be configured to be coupled to bite adjuster 1210 of removable portion 1200. Bite adjuster 1310 may include a ball 1311. Alternatively, bite adjuster 1310 may include a socket, a hinge, a universal joint, or any other suitable flexible coupling. Still alternatively, bite adjuster 1310 may include a rigid coupling. Upper-lower joint 1320 may include a hinge 1321. Alternatively, upper-lower joint 1320 may include a universal joint, a ball-and-socket joint, or any other suitable flexible coupling. It has not escaped our notice that first coupling 1120 and second coupling 1220 may be positioned between, or another similar coupling positioned between, bite adjuster 1310 and upper-lower joint 1320.

One or more of fixed portion 1100, removable portion 1200, and hinged portion 1300 may include features to indicate whether they are to be used with upper model 110 or lower model 120, or how they are to be oriented. For example, fixed portion 1100 and removable portion 1200 may be color-coded to indicate whether they are to be used with upper model 110 or lower model 120. As another example, one or more of fixed portion 1100, removable portion 1200, and hinged portion 1300 may include markings to indicate a direction they are to be oriented, or whether they are to be used with upper model 110 or lower model 120. These features help prevent re-coupling second coupling 1220 upside-down or the wrong way to first coupling 1120 when second coupling 1220 has been uncoupled from first coupling 1120.

First coupling 1120 may include a track 1121. Track 1121 may be substantially C-shaped. Alternatively, track may be substantially T-shaped or any other suitable shape. Second coupling 1220 may include a mating rail 1221 configured to be slidably coupled to track 1121. Mating rail 1221 may be substantially flat. Alternatively, mating rail 1221 may be substantially T-shaped, C-shaped, or any other suitable shape. Track 1121 may have a press fit or an interference fit with mating rail 1221. Mating rail 1221 may be infinitely adjustable or positioned anywhere along track 1121.

Track 1121 and/or mating rail 1221 may include one or more positioning features to facilitate positioning mating rail 1221 along track 1121. Track 1121 and/or mating rail 1221 may include a stop 1122 configured to limit how far mating rail 1221 may slide along track 1121. Alternatively, track 1121 and/or mating rail 1221 may include no stops 1122, which would allow for a greater range of positioning mating rail 1221 along track 1121.

Track 1121 and/or mating rail 1221 may include one or more recesses 1123 and protrusions 1223 configured to provide tactile and/or audible feedback when mating rail 1221 slides along track 1121 and a protrusion 1223 meets a recess 1123. A plurality of recesses 1123 and/or protrusions 1223 may be spaced along the length of track 1121 to provide discrete positions for mating rail 1221 along track 1121.

Track 1121 and/or mating rail 1221 may include one or more features to help prevent re-coupling mating rail 1221 upside-down or the wrong way to track 1121 when mating rail 1221 has been uncoupled from track 1121. These features help prevent flipping mating rails 1221 with respect to upper model 110 and lower model 120 when mating rails 1221 have been uncoupled from tracks 1121. Track 1121 and mating rail 1221 may be made with different dimensions or sizes for upper model 110 and lower model 120. For example, a thicker and/or wider mating rail 1221 may be made for upper model 110 and a thinner and/or narrower mating rail 1221 for lower model 120, with a taller and/or wider track 1121 being made to accommodate the thicker and/or wider mating rail 1221 and a shorter and/or narrower track 1121 the thinner and/or narrower mating rail 1221. As another example, track 1121 and mating rail 1221 may be made with a tapered or wedge shape for upper model 110, and no taper or wedge or a different taper or wedge for lower model 120. Recesses 1123 and/or protrusions 1223 may be keyed or otherwise located to encourage mating rails 1221 to be slidably coupled to tracks 1121 in a particular orientation or direction. For example, recesses 1123 and/or protrusions 1223 may be located off-center. As another example, recesses 1123 and/or protrusions 1223 may be located on one end or another of track 1121 and/or mating rail 1221.

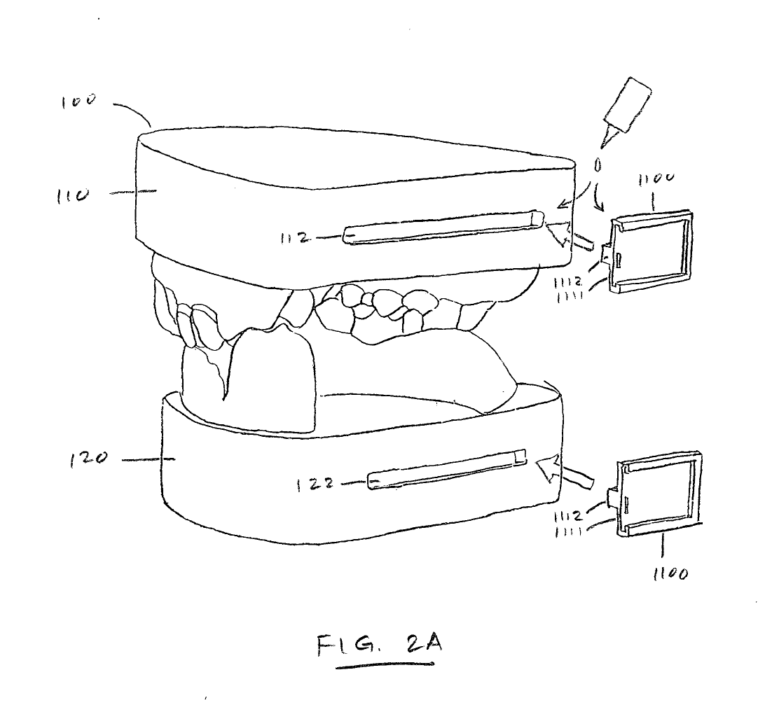

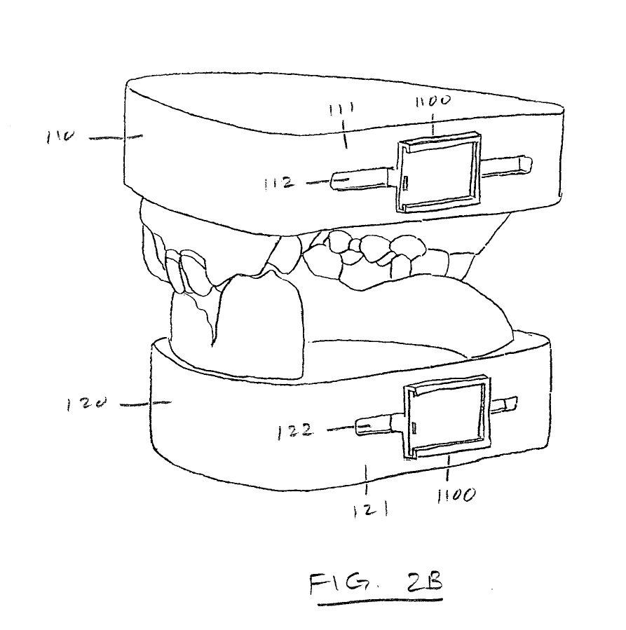

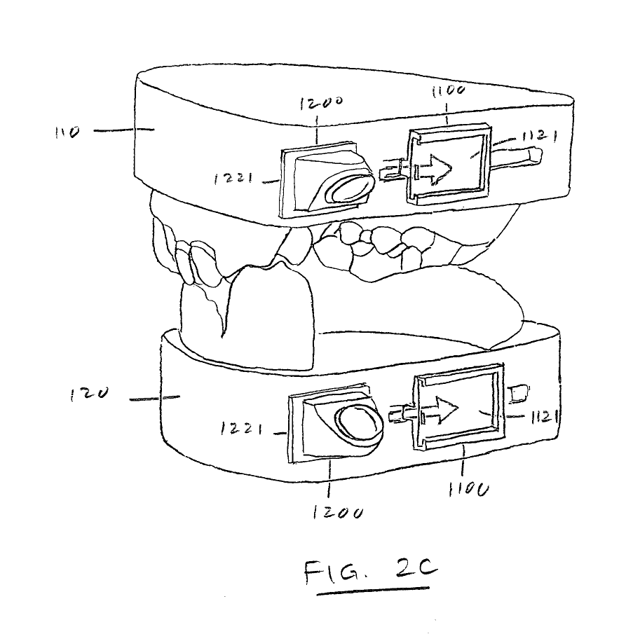

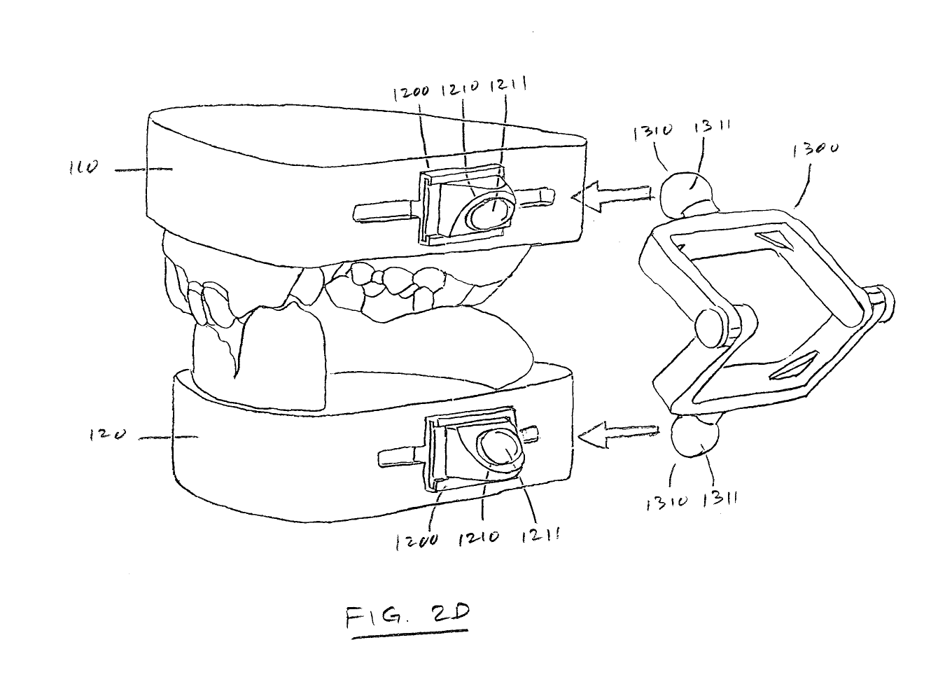

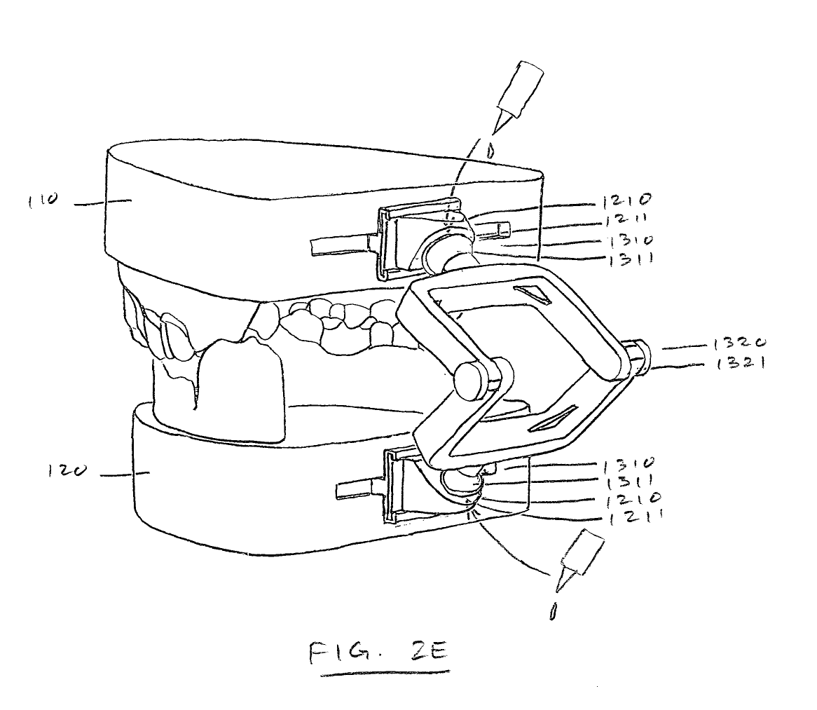

FIGS. 2A-2F show one embodiment of a method of using dental articulator 1000.

FIG. 2A shows applying an adhesive to fixed portions 1100 and/or dental model 100. An adhesive may be applied to plates 1111 and/or back surface 111 and back surface 121. An adhesive may also be applied to tabs 1112 and/or recess 112 and recess 122.

FIG. 2B shows coupling fixed portions 1100 to dental model 100. Plates 1111 may be brought into contact with back surface 111 and back surface 121. Tabs 1112 of plates 1111 may be inserted into recess 112 and recess 122.

FIG. 2C shows coupling removable portions 1200 to fixed portions 1100. Second coupling 1220 may be coupled to first coupling 1120. Mating rails 1221 may be slidably coupled to tracks 1121. Mating rails 1221 may be positioned as desired along tracks 1121.

FIG. 2D shows coupling hinged portion 1300 to removable portions 1200. Bite adjuster 1310 may be coupled to bite adjuster 1210. Balls 1311 may be inserted into sockets 1211 to form ball-and-socket joints. Upper model 110 and lower model 120 may be positioned and adjusted to reproduce a particular bite.

FIG. 2E shows fixing bite adjuster 1310 and bite adjuster 1210. After upper model 110 and lower model 120 have been positioned and adjusted, bite adjuster 1310 and bite adjuster 1210 may be fixed. One or both balls 1311 and sockets 1211 may be fixed by applying an adhesive to balls 1311 and sockets 1211. After bite adjuster 1310 and bite adjuster 1210 are fixed, upper-lower joint 1320 still allows upper model 110 and lower model 120 to be opened and closed. After balls 1311 and sockets 1211 are fixed, hinge 1321 still allows upper model 110 and lower model 120 to opened and closed.

Removable portions 1200 and hinged portion 1300 may be removed from fixed portions 1100 for a variety of reasons. For example, removable portions 1200 and hinged portion 1300 may be removed from fixed portions 1100 to adjust the bite between upper model 110 and lower model 120. In this case, new removable portions 1200 and a new hinged portion 1300 may be used. As another example, removable portions 1200 and hinged portion 1300 may be removed from fixed portions 1100 so that upper model 110 and lower model 120 may be separated and individually scanned or otherwise manipulated. This eliminates the need to separate upper model 110 and lower model 120 at upper-lower joint 1320, and reduces the size of the object to be scanned or otherwise manipulated.

FIG. 2F shows removing removable portions 1200 from fixed portions 1100. Second coupling 1220 may be uncoupled from first coupling 1210. Mating rails 1221 may be uncoupled from tracks 1121 by sliding mating rails 1221 off of tracks 1121. The steps shown in FIGS. 2C-2E may then repeated with new removable portions 1200 and a new hinged portion 1300.

Dental articulator 1000 allows dental model 100 to be adjusted and repositioned as many times as is necessary without having to remove a fixedly coupled component from dental model 100. This reduces or eliminates the risk of causing damage to dental model 100.

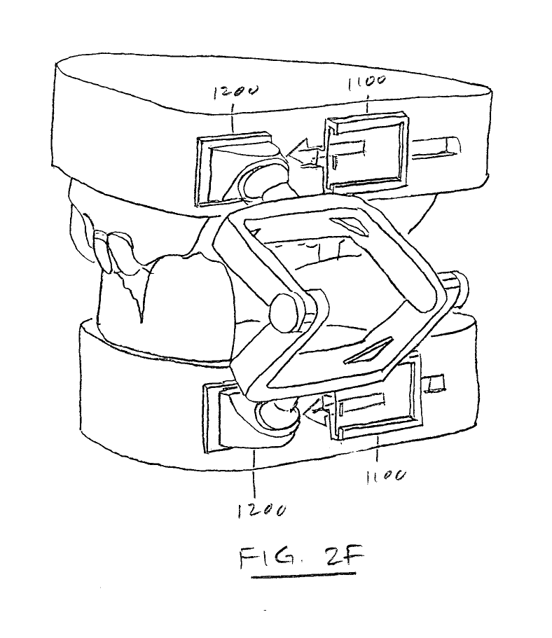

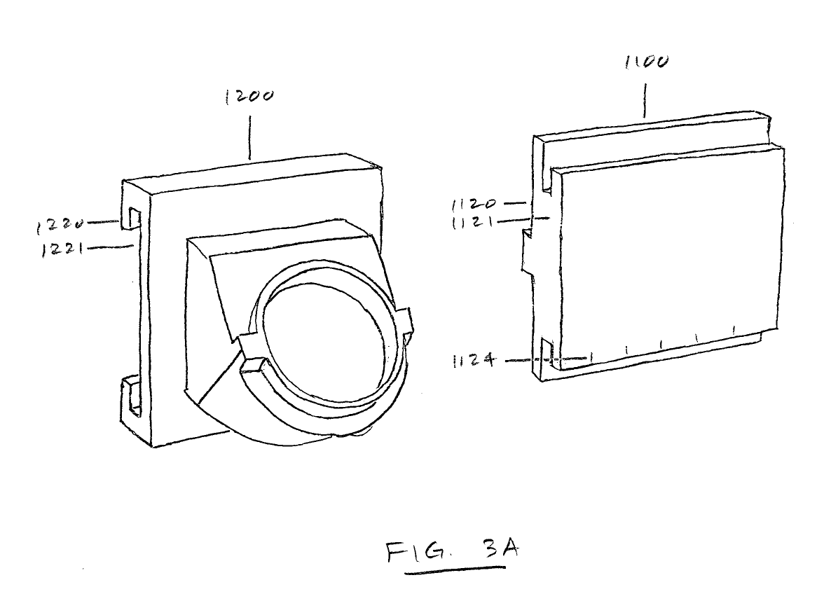

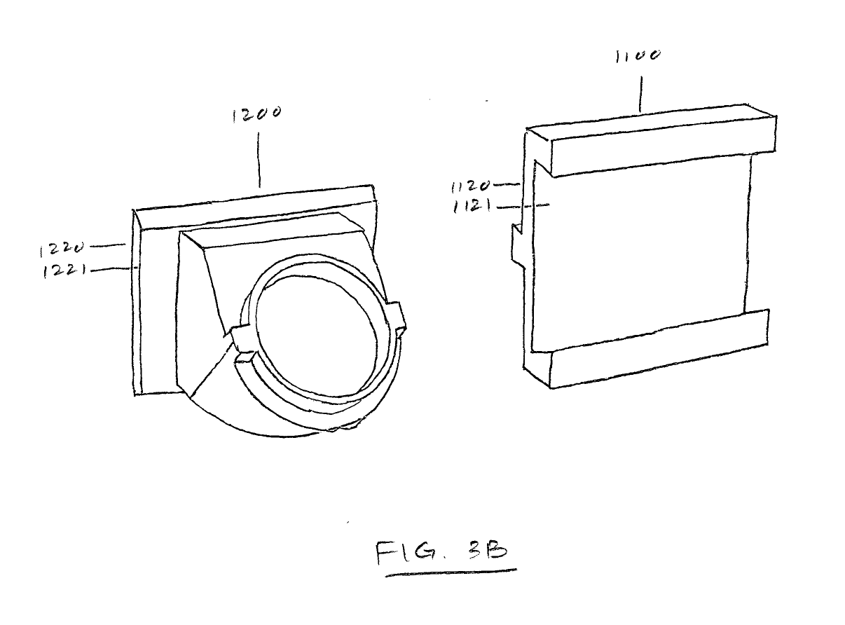

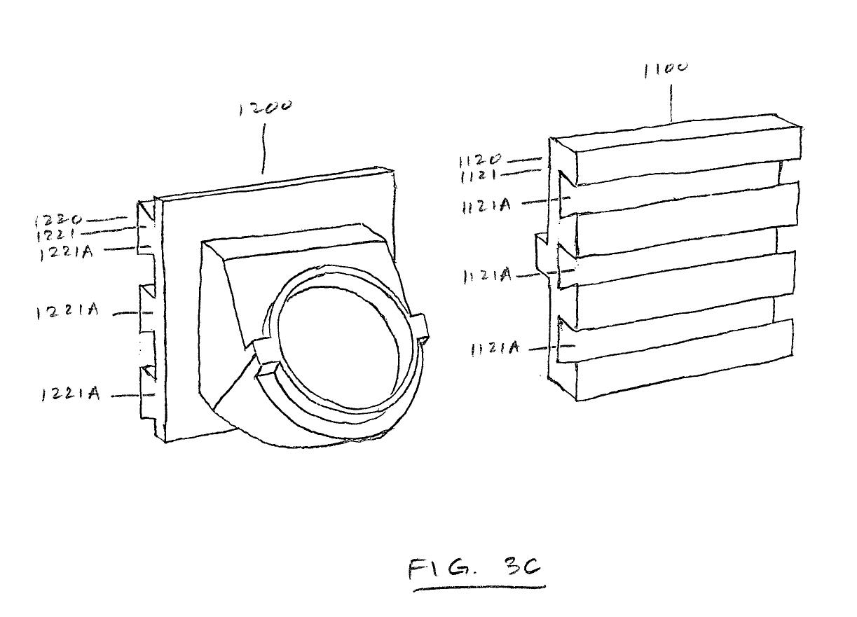

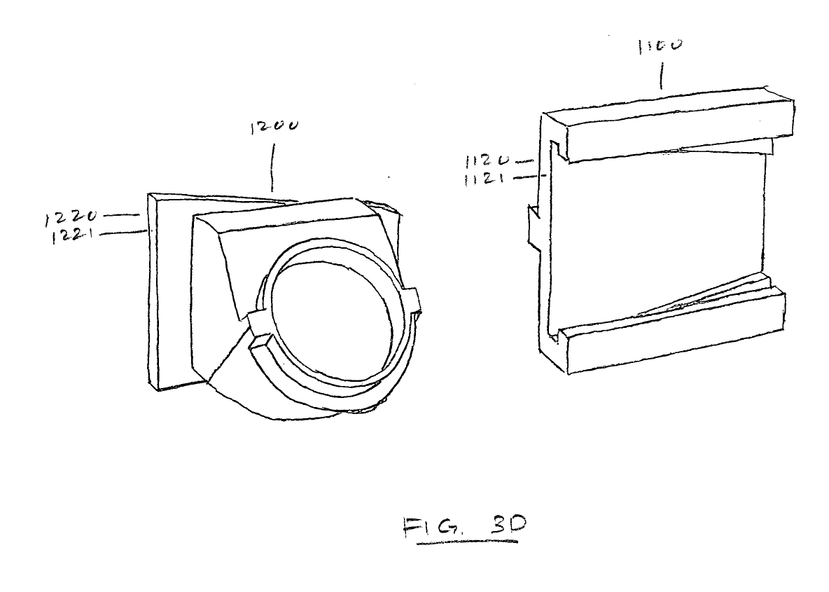

FIGS. 3A-3D show various embodiments of track 1121 and mating rail 1221.

FIG. 3A shows a track 1121 that is T-shaped. Mating rail 1221 is C-shaped. Track 1121 and/or mating rail 1221 may include markings 1124 which facilitate the positioning of mating rail 1221 along track 1121.

FIG. 3B shows a track 1121 that is trapezoidal. Mating rail 1221 is also trapezoidal. Alternatively, any suitable shape may be used.

FIG. 3C shows a track 1121 that includes one or more sub-tracks 1121A. Sub-tracks 1121A may be trapezoidal or any other suitable shape. Mating rail 1221 may include one or more sub-rails 1221A. Sub-rails may be trapezoidal or any other suitable shape. Sub-tracks 1121A and sub-rails 1221A may allow mating rail 1221 to be adjusted up and down with respect to track 1121.

FIG. 3D shows a track 1121 and/or mating rail 1221 that includes one or more non-parallel surfaces, such as a wedge-shaped surface, configured to limit how far mating rail 1221 may slide along track 1121.

FIG. 3E shows another embodiment of first coupling 1120 and second coupling 1220. First coupling 1120 may include a twist connector 1127 and a second coupling may include a mating connector 1227. Mating connector 1227 is configured to be twistably coupled to twist connector 1127.

Other embodiments of first coupling 1120 and second coupling 1220 may include spring-loaded or clip fasteners which may allow first coupling 1120 and second coupling 1220 to lock or “click” together. Such fasteners may include a release that may be squeezed or pressed to separate first coupling 1120 and second coupling 1220.

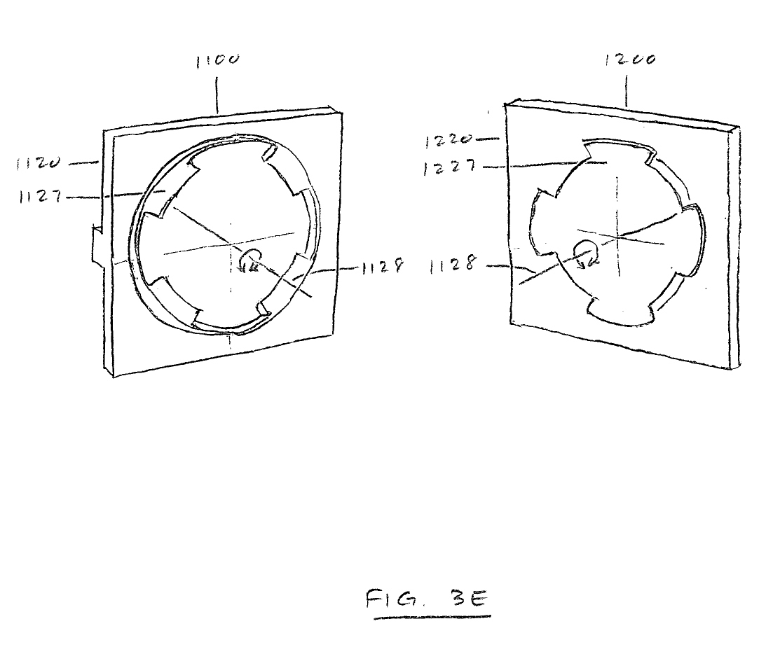

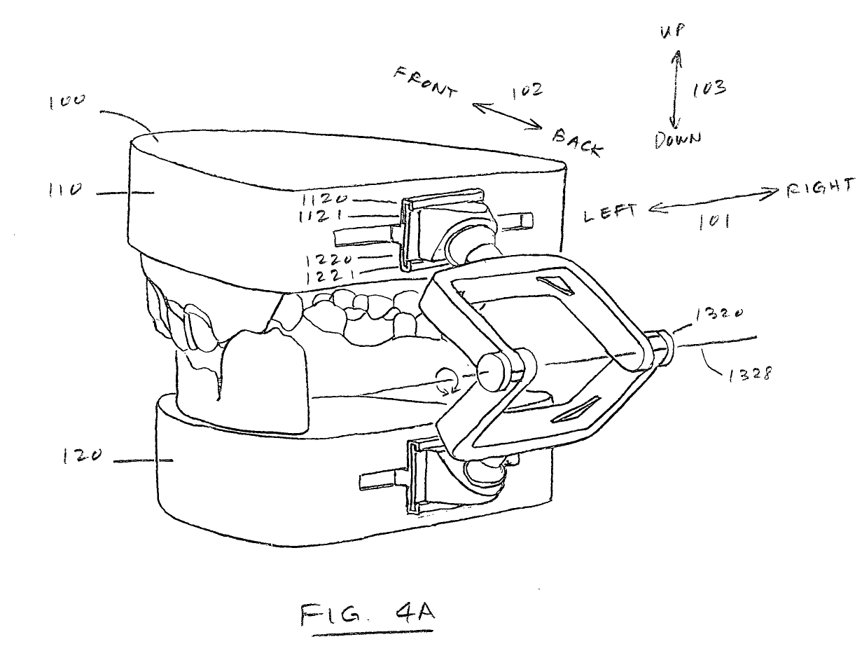

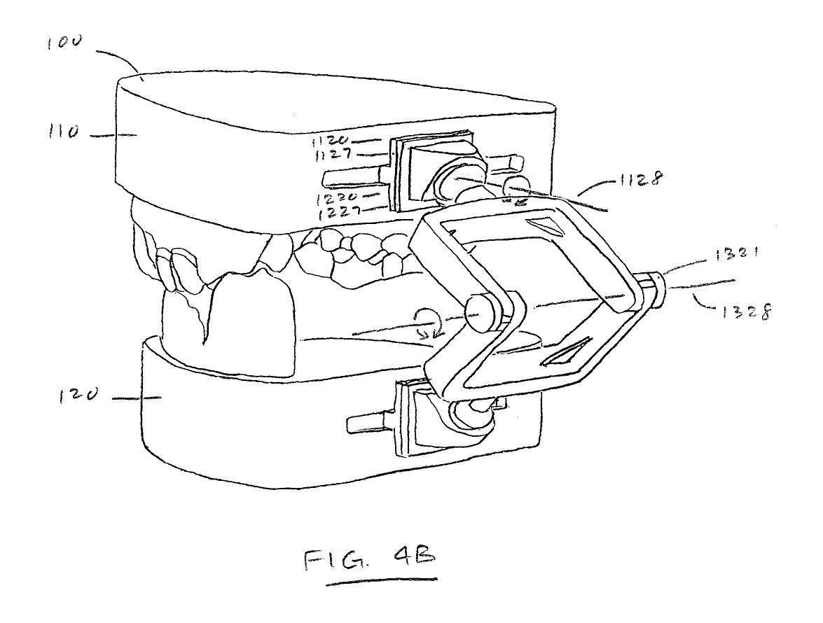

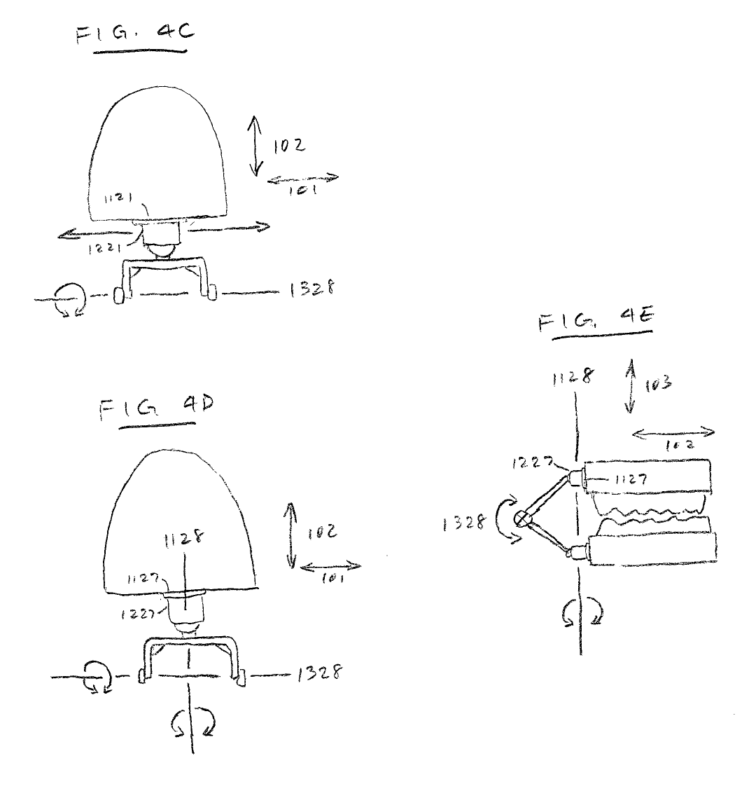

FIGS. 4A and 4C show one embodiment of a dental articulator 1000, including a track 1121 and a mating rail 1221, coupled to a dental model 100. FIGS. 4B and 4D show another embodiment of a dental articulator 1000, including a twist connector 1127 and a mating connector 1227, coupled to a dental model 100.

Dental model 100 may include a left-right direction or left-right axis 101, a front-back direction or front-back axis 102, and an up-down direction or up-down axis 103.

First coupling 1120 and second coupling 1220 may be configured to reduce the likelihood that first coupling 1120 and second coupling 1220 will become inadvertently uncoupled when subjected to the forces of opening and closing dental model 100. First coupling 1120 and second coupling 1220 may be configured to be coupled and uncoupled in a direction which is not substantially coincident with the direction of the forces generated by opening and closing dental model 100.

For example, first coupling 1120 and second coupling 1220 may be configured to be coupled and uncoupled using a pulling and/or pushing motion in a substantially left-right direction 101. Dental model 100 is opened and closed with a pulling and/or pushing motion in a substantially front-back direction 102 and up-down direction 103, and thus generates pulling and/or pushing forces in the front-back direction 102 and up-down direction 103. Because first coupling 1120 and second coupling 1220 are configured to be coupled and uncoupled in a substantially left-right direction 101, which is not substantially coincident with the front-back direction 102 and up-down direction 103 forces generated by opening and closing dental model 100, this reduces the likelihood that dental articulator 1000 will become detached from dental model 100 when dental model 100 is opened and closed.

In other words, first coupling 1120 and second coupling 1220 may be configured to have a translational degree of freedom along an axis that is substantially parallel to an axis of rotation 1328 about which hinge 1321 rotates.

As shown in FIGS. 4A and 4C, track 1121 may be oriented in a substantially left-right direction 101. Track 1121 and mating rail 1221 may thus be configured to be coupled and uncoupled with a pulling and/or pushing motion in a substantially left-right direction 101. However, this is not meant to limit the orientation of track 1121, and a substantially up-down direction 103 or any other orientation may be used.

As another example, first coupling 1120 and second coupling 1220 may be configured to be coupled and uncoupled using a twisting motion about an axis of rotation 1128. Dental model 100 is opened and closed with a rotating motion about an axis of rotation 1328 of hinge 1321, and thus generates twisting forces about the axis of rotation 1328 of hinge 1321. Because first coupling 1120 and second coupling are configured to be coupled and uncoupled about an axis of rotation 1128, which is not substantially coincident with the twisting forces generated by opening and closing dental model 100, this reduces the likelihood that dental articulator 1000 will become detached from dental model 100 when dental model 100 is opened and closed.

In other words, first coupling 1120 and second coupling 1220 may be configured to have a rotational degree of freedom along an axis that is substantially normal to an axis of rotation 1328 about which hinge 1321 rotates.

As shown in FIGS. 4B and 4D, twist connector 1127 may have an axis of rotation 1128 oriented along a substantially front-back axis 102. Alternatively, as shown in FIG. 4E, twist connector 1127 may have an axis of rotation 1128 along a substantially up-down axis 103, or anywhere between front-back axis 102 and up-down axis 103. Twist connector 1127 and mating connector 1227 may thus be configured to be coupled and uncoupled with a twisting motion about axis of rotation 1128. However, this is not meant to limit the orientation of twist connector 1127, and any other orientation may be used.

First coupling 1120 and/or second coupling 1220 may be at least partially made of plastic. Alternatively, first coupling 1120 and/or second coupling 1220 may be at least partially made of metal or any other suitable material. Plastic may be more flexible and/or slippery than metal or other materials, and thus may not be able to generate enough force to satisfactorily lock threaded components in position. Thus, first coupling 1120 and second coupling 1220 may be configured to be coupled and uncoupled without the use of threaded components, such as one or more of screws, nuts, and bolts.

While the foregoing has been with reference to particular embodiments of the invention, it will be appreciated by those skilled in the art that changes in these embodiments may be made without departing from the principles and spirit of the invention.

What is claimed is:

1. A dental articulator, comprising:
a fixed portion configured to be fixedly coupled to a dental model, the fixed portion having a first coupling; and
a removable portion configured to be coupled to an upper-lower joint, the removable portion having a second coupling configured to be removably coupled to the first coupling.

2. The dental articulator of claim 1, wherein the first coupling includes a track and the second coupling includes a mating rail configured to be slidably coupled to the track.

3. The dental articulator of claim 2, wherein the track is C-shaped.

4. The dental articulator of claim 2, wherein the mating rail is flat.

5. The dental articulator of claim 2, wherein the track and/or the mating rail includes a stop.

6. The dental articulator of claim 2, wherein the track includes a recess and the mating rail includes a protrusion, the recess and the protrusion configured to provide tactile and/or audible feedback when mating rail slides along track and the protrusion meets the recess.

7. The dental articulator of claim 2, wherein the track is oriented in a substantially left-right direction with respect to the dental model, and wherein the track and the mating rail are configured to be coupled and uncoupled in a left-right direction with respect to the dental model.

8. The dental articulator of claim 1, wherein the first coupling is coupled to a back surface of the dental model.

9. The dental articulator of claim 1, wherein the upper-lower joint includes a hinge.

10. The dental articulator of claim 1, wherein the upper-lower-joint is coupled to the removable portion with a bite adjuster.

11. The dental articulator of claim 10, wherein the bite adjuster includes a ball-and-socket joint.

12. The dental articulator of claim 1, wherein the first coupling and the second coupling are configured to be coupled and uncoupled in a left-right direction with respect to the dental model.

13. The dental articulator of claim 1, wherein the first coupling and the second coupling may be coupled and uncoupled without using any threaded components.

14. A method for using a dental articulator, the method comprising:
fixedly coupling a fixed portion to a dental model, the fixed portion having a first coupling;
removably coupling a removable portion to the fixed portion, the removable portion having a second coupling configured to be removably coupled to the fixed portion; and
coupling an upper-lower joint to the removable portion.

15. The method of claim 14, further comprising:
removing the removable portion and the upper-lower joint from the fixed portion; and
removably coupling a new removable portion to the fixed portion.
